(19) United States
(12) Patent Application Publication
(10) Pub. No.: US 2017/0287338 A1
(43) Pub. Date: Oct. 5, 2017

(54) SYSTEMS AND METHODS FOR IMPROVING FIELD OF VIEW AT INTERSECTIONS

(71) Applicant: Ford Global Technologies, LLC, Dearborn, MI (US)

(72) Inventors: Cynthia M. Neubecker, Westland, MI (US); Omar Makke, Lyon Township, MI (US)

(21) Appl. No.: 15/091,330

(22) Filed: Apr. 5, 2016

(51) Int. Cl. G08G 1/16; B60R 1/00

(52) U.S. Cl. CPC G08G 1/168; B60R 1/00

(57) ABSTRACT

Systems and methods for improving field of view at intersections are disclosed. An example first vehicle includes a camera and a blind spot assister. The example blind spot assister is configured to, when the first vehicle is parked within a threshold distance of an intersection, establish a first wireless connection with a second vehicle in response to a request broadcast by the second vehicle, connect to a second wireless network using credentials received via the first wireless network; and stream video from the camera to the second vehicle via the second wireless network.

### TECHNICAL FIELD

The present disclosure generally relates to semi-autonomous vehicles and, more specifically, systems and methods for improved field of view at intersections.

### BACKGROUND

At many intersections in busy areas, vehicles often park very close to intersections. These vehicles can obstruct views of a road approaching the intersection. For drivers trying to merge or turn onto the road, this can create blind spots. These blind spots are especially troublesome when the cross traffic does is not controlled. For example, blind spots may troublesome when a vehicle on a side street controlled by a stop sign is turning onto a main street not controlled by a stop sign or traffic signal. Traditionally, to overcome the blind spots, vehicles to move into the intersection until the drivers can see past the vehicle park too close to the intersection.

### SUMMARY

The appended claims define this application. The present disclosure summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

Exemplary embodiments providing systems and methods for improving field of view at intersections are disclosed. An example first vehicle includes a camera and a blind spot assister. The example blind spot assister is configured to, when the first vehicle is parked within a threshold distance of an intersection, establish a first wireless connection with a second vehicle in response to a request broadcast by the second vehicle, connect to a second wireless network using credentials received via the first wireless network; and stream video from the camera to the second vehicle via the second wireless network.

An example method includes, when a first vehicle is parked within a threshold distance of an intersection, establishing a first wireless connection with a second vehicle in response to a request broadcast by the second vehicle. The example method also includes connecting to a second wireless network using credentials received via the first wireless network. Additionally, the example method includes streaming video from a camera of the first vehicle to the second vehicle via the second wireless network.

An example tangible computer readable medium comprises instruction that, when executed, cause a first vehicle to, when the first vehicle is parked within a threshold distance of an intersection, establish a first wireless connection with a second vehicle in response to a request broadcast by the second vehicle. The example instructions also cause the first vehicle to connect to a second wireless network using credentials received via the first wireless network. The example instructions, when executed, cause the first vehicle to stream video from a camera of the first vehicle to the second vehicle via the second wireless network.

An example disclosed system includes a first vehicle and a second vehicle. The example first vehicle broadcasts a request for the second vehicle to respond if the second vehicle is parked within a threshold distance of an intersection. When the second vehicle responds, the first and second vehicles establish a first wireless connection. The first vehicle creates a second wireless connection. The first vehicle sends credentials to the second vehicle via the first wireless connection. The second vehicle uses the credentials to connect to the second wireless network. The second vehicle streams video from a rear camera to the first vehicle over the second wireless connection.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIGS. 1A through 1D depict vehicles operating in accordance with the teachings of this disclosure to improve the field of view at intersections.

FIG. 2 illustrates electronic components of the vehicles of FIGS. 1A through 1D.

FIG. 3 is a flowchart of an example method to improve the field of view at intersections that may be implemented by the electronic components of FIG. 2.

FIG. 4 is a flowchart of an example method to provide streaming video from the rear camera of a parked vehicle to a turning vehicle that may be implemented by the electronic components of FIG. 2.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

Vehicles (such as, cars, trucks, vans, sport utility vehicles, etc.) can be classified as non-autonomous, semi-autonomous, and autonomous. Non-autonomous vehicles are vehicles that have limited systems to affect vehicle performance (e.g., cruise control, anti-lock brakes, etc.), but do not include systems to assist the driver controlling the vehicle. Semi-autonomous vehicles are vehicles that have systems (e.g. adaptive cruise control, parking assistance, etc.) that assist control of the vehicle in some situations. Autonomous vehicles are vehicles that have systems to control the vehicle without driver interaction after a destination has been selected. Vehicle may also be classified as communicative or non-communicative. Communicative vehicles have systems, such as a cellular modem, a wireless local area network system, a vehicle-to-vehicle (V2V) communication system, etc., that facilitate the vehicle communicating with other vehicles and/or communication-enabled infrastructure.

As disclosed herein below, a communicative vehicle at an intersection (sometimes referred to herein as a “requesting vehicle”) requests that communicative, semi-autonomous or autonomous vehicles (sometimes referred to hereafter as “responsive parked vehicles”) parked too close to the intersection ameliorate the blind spots. To ameliorate the blind spots, the responsive parked vehicles will (a) move to away from the intersection if able, and/or (b) provide a video stream of the blind spots via a rear camera of the responsive parked vehicles. The driver of a responsive parked vehicle parked too close to an intersection may set the vehicle to move away from the intersection when able. For example, if the front of the responsive parked vehicle is parked too close (e.g., within 30 feet (9.1 meters) to the intersection, the responsive parked vehicle may, from time to time, activate its range detects sensors (e.g., ultrasonic sensors, RADAR, etc.) to determine whether there is room behind it to move backwards. In such an example, if there is room to move backwards, a parking assist system of the responsive parked vehicle moves it away from the intersection.

In some examples disclosed below, the requesting vehicle and the responsive parked vehicle(s) communicate via Direct Short Range Communication (DSRC). The requesting vehicle creates an ad hoc wireless network (utilizing a Wi-Fi® network, a Bluetooth® network, or a ZigBee® network, etc.) and sends temporary credentials to the responsive parked vehicle(s) via DSRC. The responsive parked vehicle(s) use(s) the temporary credentials to connect to the ad hoc wireless network. When the responsive parked vehicle(s) is/are connected, the responsive parked vehicle(s) stream(s) video from a rear camera to the requesting vehicle via the ad hoc wireless network. In some examples, the responsive parked vehicle(s) determine(s) whether there is an object (such as another vehicle) that obstructs the view of its rear camera. For example, the responsive parked vehicle(s) may activate its range detection sensors to determine if there is another vehicle close (e.g., within 3 feet (0.91 meters), etc.) to it. If there is another vehicle close, the parking assist system of the responsive vehicle repositions the responsive vehicle so that its camera is angled towards the street.

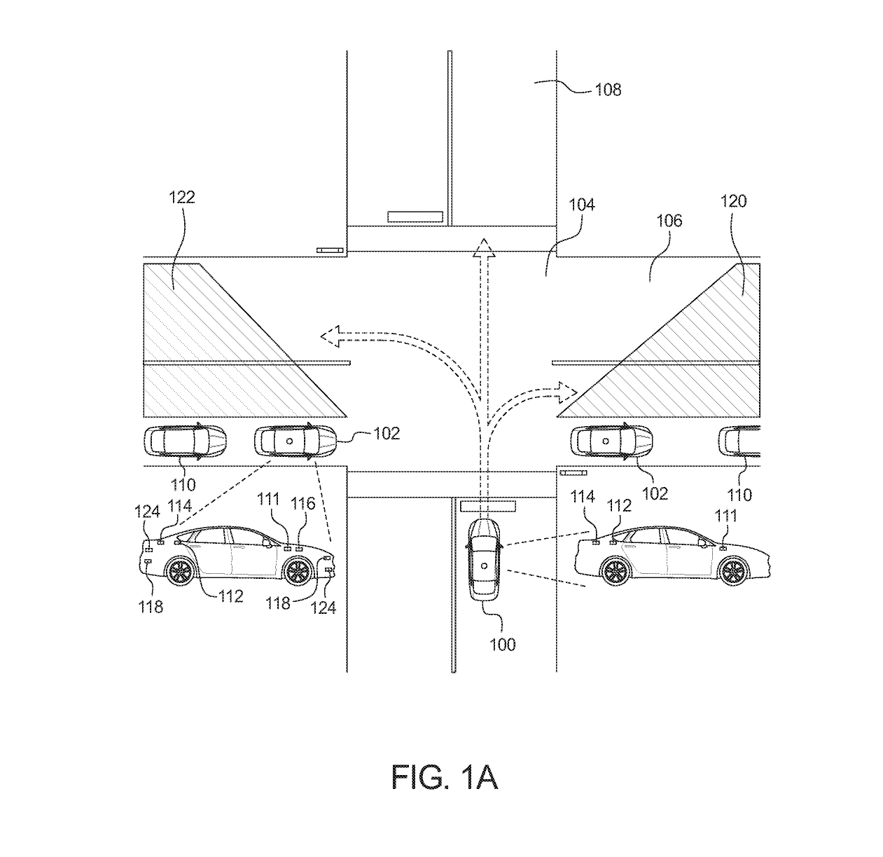

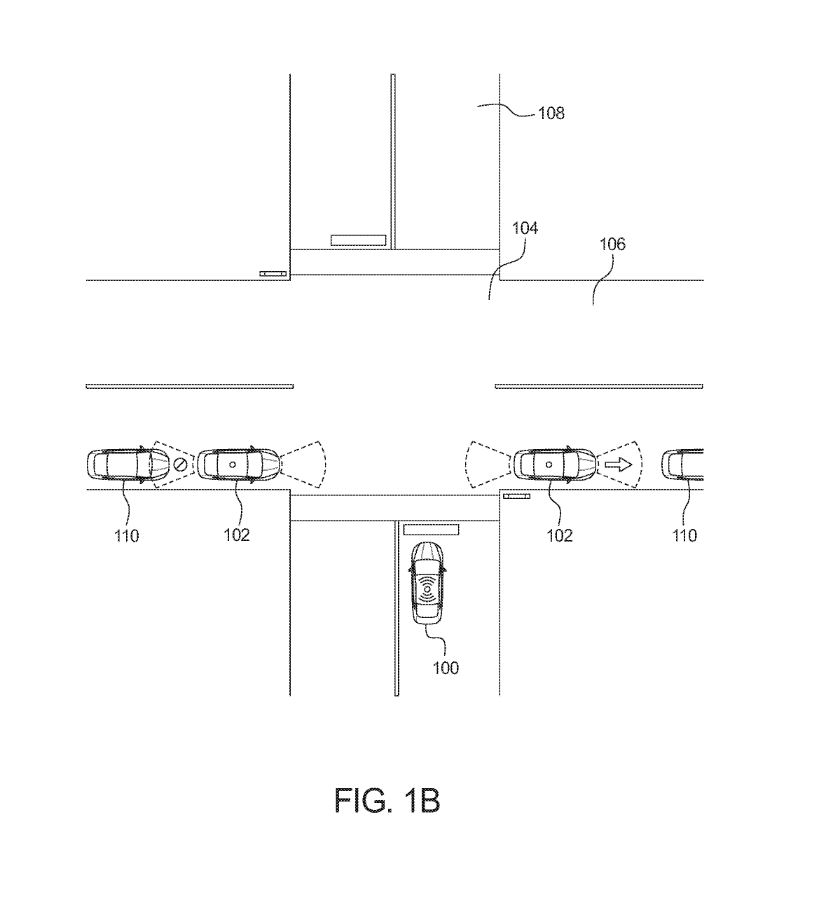

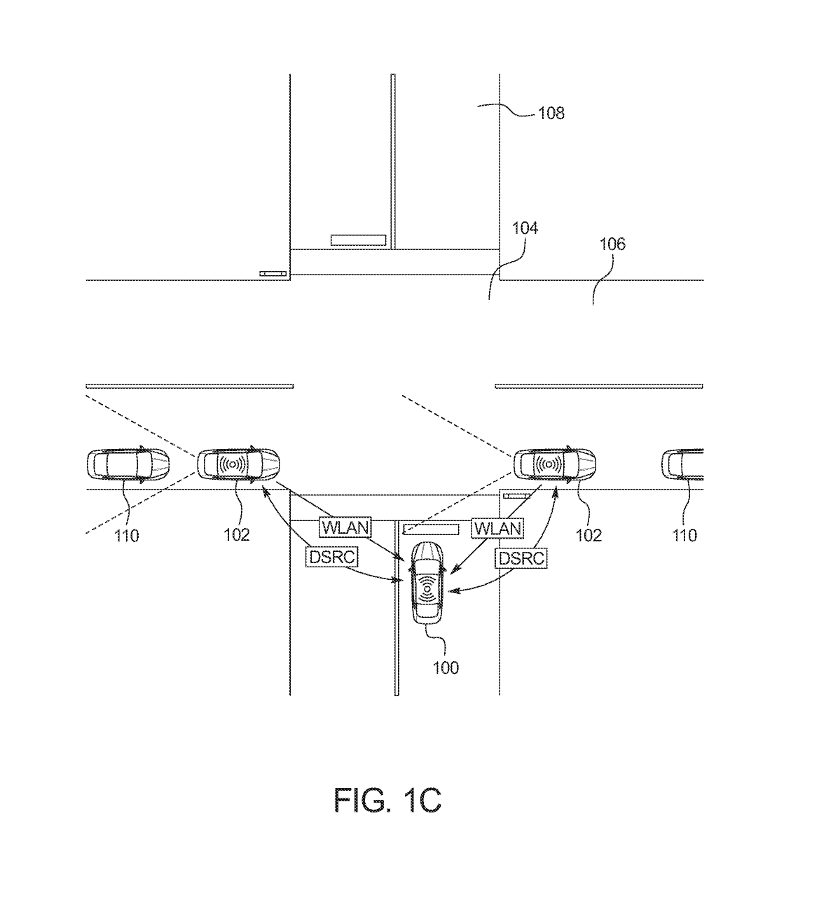

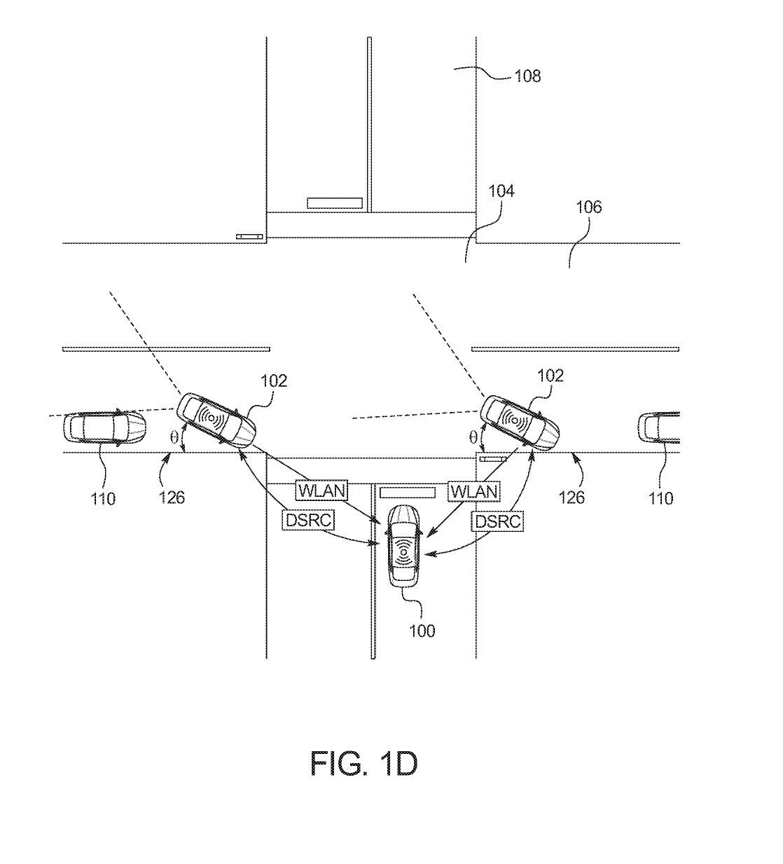

FIGS. 1A through 1D depict vehicles 100 and 102 operating in accordance with the teachings of this disclosure to improve the field of view at an intersection 104. The illustrate example depicts the intersection 104 with a major road 106 intersecting a minor road 108. However, the intersection 104 may include two or more roads of any designation (e.g., major, minor, arterial, etc.). The illustrated examples include a requesting vehicle 100, and responsive parked vehicles 102 and non-responsive parked vehicles 110 parked close to the intersection 104. The example requesting vehicle 100 includes an intersection blind spot assister 111, a DSRC module 112 and a wireless local area network (WLAN) module 114. The example responsive parked vehicles 102 include the intersection blind spot assister 111, the DSRC module 112, the WLAN module 114, a parking assist system 116, and on or more cameras 118. The example non-responsive parked vehicles 110 do not include at least one of the DSRC module 112, the WLAN module 114, or the parking assist system 116.

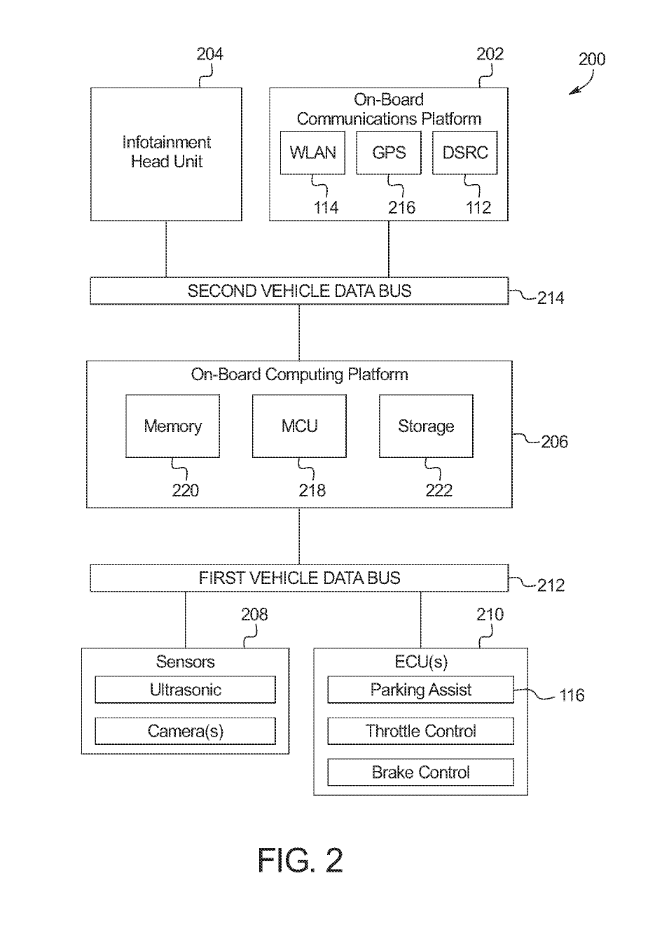

The intersection blind spot assister 111 of the responsive parked vehicles 102 determine whether the corresponding responsive parked vehicles 102 is parked too close (e.g., within 30 feet (9.1 meters), etc.) to the intersection 104. As used herein, “parked too close” refers to areas near the intersection 104 where the parked vehicles 102 and 110 create blind spots 120 and 122. The areas near the intersection wherein the vehicles 102 and 110 are parked too close may be defined by laws and/or regulations of the jurisdiction where the intersection is located. For example, a jurisdiction may define parking too close to be 20 feet (6.1 meters) from a marked crosswalk or 15 feet (4.6 meters) from the intersection 104. In some examples, when the driver parks the responsive parked vehicle 102, the driver indicates, through an interface on an infotainment head unit (e.g., the infotainment head unit 204 of FIG. 2 below), that the responsive parked vehicle 102 is parked too close to the intersection 104. Alternatively, in some examples, the intersection blind spot assister 111 uses coordinates from a global position system (GPS) receiver (e.g., the GPS receiver 216 of FIG. 2 below), a high definition map, and range detection sensors 124 to determine the location of the responsive parked vehicle 102 and whether the responsive parked vehicle 102 is too close to the intersection 104.

To conserve battery power, the DSRC module 112 and the parking assist system 116 are in a low power mode. In low power mode, the DSRC module 112 listens for DSRC messages (e.g., from the requesting vehicle 100) for a period of time (e.g., for five seconds, etc.). If the DSRC module 112 receives a DSRC message (e.g., a broadcast in range, a directed message, etc.), the intersection blind spot assister 111 wakes up other vehicle systems (such as the parking assist system 116, the range detection sensors 124, the camera(s) 118, etc.). This is sometimes referred to as “wake-on-DSRC.” In some examples, from time to time (e.g., every minute, every five minutes, etc.), the intersection blind spot assister 111 wakes up to determine if the parked vehicle 102 can move away from the intersection 104 even when a DSRC message is not received by the DSRC module 112. In such examples, upon making the determination (e.g., can move away, cannot move away) and/or taking an action (e.g., moving away from the intersection 104), the intersection blind spot assister 111 returns to low power mode.

In some examples, the driver of the responsive parked vehicle 102 inputs a command (e.g., via the infotainment head unit 204) to move away from the intersection 104 when possible. In such examples, intersection blind spot assister 111 wakes the parking assist system 116 and the range detection sensors 124 from time to time (e.g., every thirty seconds, every minute, every five minutes, etc.) to determine whether there is space (e.g., a foot (0.3 meters) or more) to move the responsive parked vehicle 102 away from the intersection 104. For example, a vehicle in front of the responsive parked vehicle 102 may have moved since the responsive parked vehicle 102 was parked. In such examples, the intersection blind spot assister 111 uses the parking assist system 116 to move the responsive parked vehicle 102 into the available space.

FIG. 1A illustrates the requesting vehicle 100 preparing to proceed through the intersection 104 via the minor road 108. In the illustrated example, the vehicles 102 and 110 are obstructing the view of the requesting vehicle 100 of the major road 106 to create blind spots 120 and 122. The blind spots 120 and 122 obscure whether other vehicle(s) are approaching the intersection 104 via the major road 106. In the illustrated example of FIG. 1A, the intersection blind spot assister 111 of the requesting vehicle 100 broadcasts a message via the DSRC module 112. The message includes the location of the requesting vehicle 100 and a request for responsive vehicle(s) 102 at the intersection 104 to move away from the intersection 104 if able. In some examples, the message is initiated by the driver of the requesting vehicle 100 via an interface on the infotainment head unit 204.

FIG. 1B illustrates the responsive(s) vehicle 102 within range of the requesting vehicle 100 (e.g., 982 feet (300 meters), etc.) waking up in response to the message broadcast by the requesting vehicle 100. The intersection blind spot assister(s) 111 of the responsive vehicle(s) 102 that determine that the corresponding responsive parked vehicle 102 is not parked too close to the intersection 104 return(s) the DSRC module 112 to the low power mode. The intersection blind spot assister(s) 111 of the remaining responsive vehicle(s) 102 determine if the corresponding responsive parked vehicle 102 is parked at the intersection 104 at which the requesting vehicle 100 is stopped. The intersection blind spot assister(s) 111 of the responsive parked vehicle(s) 102 that determines that the responsive parked vehicle 102 is not at the intersection 104 at which the requesting vehicle 100 is stopped returns the DSRC module 112 to the low power mode. The intersection blind spot assister(s) 111 of the remaining responsive vehicle(s) 102 determine if the corresponding responsive parked vehicle 102 is able to move away from the intersection 104.

In some examples, the intersection blind spot assister 111 uses the range detection sensors 124 to determine whether there is space to move away from the intersection 104. For example, if one of the responsive parked vehicles 102 is parked so that the rear of the responsive parked vehicle 102 is too close to the intersection 104, the intersection blind spot assister 111 uses the range detection sensors 124 on the front of the responsive parked vehicle 102 to determine whether there is space to move forward. If the intersection blind spot assister 111 determines that the responsive parked vehicle 102 is able to move away from the intersection, the intersection blind spot assister(s) 111 instructs the parking assist system 116 to move the responsive parked vehicle 102. The responsive parked vehicles 102 then return to low power mode.

FIG. 1C depicts the intersection blind spot assister 111 of the requesting vehicle 100 broadcasting a message via the DSRC module 112 that includes the location of the requesting vehicle 100 and a request for the responsive parked vehicle(s) 102 to respond if they are (a) parked too close to the intersection 104, and (b) can provides video from one of their cameras 118 via the WLAN module 114. Using a non-safety channel as defined by DSRC, the intersection blind spot assister 111 establishes direct connections via DSRC with the responsive parked vehicle(s) 102 that respond. The intersection blind spot assister 111 creates an ad hoc wireless network using the WLAN module 114. The WLAN module 114 generates unique credentials (e.g. credentials that are valid just for this instance of the ad hoc wireless network) for the ad hoc wireless network. Through the DSRC direct connections, the intersection blind spot assister 111 sends the responsive parked vehicle(s) 102 the credentials to the ad hoc wireless network. The intersection blind spot assister(s) 111 of the responsive parked vehicle(s) 102 use the credentials to connect to the ad hoc wireless network. Once connected to the ad hoc wireless network, the intersection blind spot assister(s) 111 of the responsive parked vehicle(s) 102 stream video from one of the cameras 118 (e.g., the rear camera, the dash board camera, etc.) over the ad hoc wireless network. In some examples, the intersection blind spot assister(s) 111 of the responsive parked vehicle(s) 102 also transmits other sensor data, such as RADAR sensor data. The intersection blind spot assister 111 of the requesting vehicle 100 receives the stream(s) via the WLAN module 114 and displays the video streams on the infotainment head unit 204 (e.g. on a center console display). Alternatively, in some examples, the blind spot assister(s) 111 of the responsive parked vehicle(s) 102 stream video from one of the cameras 118 over the DSRC direct connection(s).

In some examples, the intersection blind spot assister(s) 111 of the responsive parked vehicle(s) 102 determine whether the corresponding camera 118 of interest (e.g., the rear camera) is blocked and/or otherwise does not provide a view of one of the blind spots 120 and 122. In some such examples, to determine that the rear camera 118 is blocked, the intersection blind spot assister 111 uses the range detection sensors 124 of the responsive parked vehicle 102. In some such examples, when an object (e.g., another vehicle, etc.) is detected within a threshold range (e.g., 3 feet (0.91 meters), etc.), the intersection blind spot assister 111 determines that the rear camera 118 is blocked. As depicted in FIG. 1D, in response to determining the rear camera 118 is blocked, the intersection blind spot assister 111 instructs the parking assist system 116 of the corresponding responsive parked vehicle 102 to reposition the responsive parked vehicle 102 so that the rear camera 118 is positioned at an angle (θ) relative to a curb 126. While the example illustrated in FIG. 1D depicts the intersection blind spot assister 111 repositioning the rear of the responsive parked vehicle 102 to improve the view of the rear camera 118, in some examples, the intersection blind spot assister 111 may reposition the front of the responsive parked vehicle 102 to improve the view of the front camera 118. In some examples, the intersection blind spot assister 111 of the responsive parked vehicle 102 repositions the responsive parked vehicle 102 to have an angle (θ) of ten degrees relative to the curb 126. The after the requesting vehicle 100 proceeds through the intersection 104, the intersection blind spot assister 111 of the requesting vehicle 100 terminates the ad hoc wireless network. In response, the intersection blind spot assister(s) 111 of the repositioned responsive parked vehicle(s) 102 instructs the parking assist system 116 to return the responsive parked vehicle 102 to its original position. The DSRC module 112, the WLAN module 114, and/or the parking assist system 116 return to the low powered mode.

FIG. 2 illustrates electronic components 200 of the vehicles 100 and 102 of FIGS. 1A through 1D. The electronic components 200 include an example on-board communications platform 202, the example infotainment head unit 204, an on-board computing platform 206, example sensors 208, example ECUs 210, a first vehicle data bus 212, and second vehicle data bus 214.

The on-board communications platform 202 includes wired or wireless network interfaces to enable communication with external networks. The on-board communications platform 202 also includes hardware (e.g., processors, memory, storage, antenna, etc.) and software to control the wired or wireless network interfaces. In the illustrated example, the on-board communications platform 202 includes the WLAN module 114, the GPS receiver 216, and the DSRC module 112. The WLAN module 114 includes one or more controllers that facilitate creating and joining the ad hoc wireless network, such as a Wi-Fi® controller (including IEEE 802.11 a/b/g/n/ac or others), a Bluetooth® controller (based on the Bluetooth® Core Specification maintained by the Bluetooth Special Interest Group), and/or a ZigBee® controller (IEEE 802.15.4). The on-board communications platform 202 may also include controllers for other standards-based networks (e.g., Global System for Mobile Communications (GSM), Universal Mobile Telecommunications System (UMTS), Long Term Evolution (LTE), Code Division Multiple Access (CDMA), WiMAX (IEEE 802.16 m); Near Field Communication (NFC); and Wireless Gigabit (IEEE 802.11 ad), etc.). Further, the external network(s) may be a public network, such as the Internet; a private network, such as an intranet; or combinations thereof, and may utilize a variety of networking protocols now available or later developed including, but not limited to, TCP/IP-based networking protocols. The on-board communications platform 202 may also include a wired or wireless interface to enable direct communication with an electronic device (such as, a smart phone, a tablet computer, a laptop, etc.).

The example DSRC modules 112 include antenna(s), radio(s) and software to broadcast messages and to establish direct connections between vehicles 100 and 102. DSRC is a wireless communication protocol or system, mainly meant for transportation, operating in a 5.9 GHz spectrum band. More information on the DSRC network and how the network may communicate with vehicle hardware and software is available in the U.S. Department of Transportation's Core June 2011 System Requirements Specification (SyRS) report (available at http://www its.dot.gov/meetings/pdf/CoreSystem_SE_SyRS_RevA%20(2011-06-13).pdf), which is hereby incorporated by reference in its entirety along with all of the documents referenced on pages 11 to 14 of the SyRS report. DSRC systems may be installed on vehicles and along roadsides on infrastructure. DSRC systems incorporating infrastructure information is known as a “roadside” system. DSRC may be combined with other technologies, such as Global Position System (GPS), Visual Light Communications (VLC), Cellular Communications, and short range radar, facilitating the vehicles communicating their position, speed, heading, relative position to other objects and to exchange information with other vehicles or external computer systems. DSRC systems can be integrated with other systems such as mobile phones.

Currently, the DSRC network is identified under the DSRC abbreviation or name. However, other names are sometimes used, usually related to a Connected Vehicle program or the like. Most of these systems are either pure DSRC or a variation of the IEEE 802.11 wireless standard. The term DSRC will be used throughout herein. However, besides the pure DSRC system it is also meant to cover dedicated wireless communication systems between cars and roadside infrastructure system, which are integrated with GPS and are based on an IEEE 802.11 protocol for wireless local area networks (such as, 802.11 p, etc.).

The infotainment head unit 204 provides an interface between the vehicles 100 and 102 and users (e.g., drivers, passengers, etc.). The infotainment head unit 204 includes digital and/or analog interfaces (e.g., input devices and output devices) to receive input from the user(s) and display information. The input devices may include, for example, a control knob, an instrument panel, a digital camera for image capture and/or visual command recognition, a touch screen, an audio input device (e.g., cabin microphone), buttons, or a touchpad. The output devices may include instrument cluster outputs (e.g., dials, lighting devices), actuators, a dashboard panel, a heads-up display, a center console display (e.g., a liquid crystal display (“LCD”), an organic light emitting diode (“OLED”) display, a flat panel display, a solid state display, or a heads-up display), and/or speakers. The infotainment head unit 204 of the requesting vehicle 100 displays video(s) received by the responsive parked vehicles 102 on the center console display.

The on-board computing platform 206 includes a processor or controller 218, memory 220, and storage 222. In some examples, the on-board computing platform 206 is structured to include the intersection blind spot assister 111. Alternatively, in some examples, the intersection blind spot assister 111 may be incorporated into an ECU 210 with its own processor and memory. The processor or controller 218 may be any suitable processing device or set of processing devices such as, but not limited to: a microprocessor, a microcontroller-based platform, a suitable integrated circuit, one or more field programmable gate arrays (FPGSs), and/or one or more application-specific integrated circuits (ASICs). The memory 220 may be volatile memory (e.g., RAM, which can include non-volatile RAM, magnetic RAM, ferroelectric RAM, and any other suitable forms); non-volatile memory (e.g., disk memory, FLASH memory, EPROMs, EEPROMs, memristor-based non-volatile solid-state memory, etc.), unalterable memory (e.g., EPROMs), and read-only memory. In some examples, the memory 220 includes multiple kinds of memory, particularly volatile memory and non-volatile memory. The storage 222 may include any high-capacity storage device, such as a hard drive, and/or a solid state drive.

The memory 220 and the storage 222 are a computer readable medium on which one or more sets of instructions, such as the software for operating the methods of the present disclosure can be embedded. The instructions may embody one or more of the methods or logic as described herein. In a particular embodiment, the instructions may reside completely, or at least partially, within any one or more of the memory 220, the computer readable medium, and/or within the processor 218 during execution of the instructions.

The terms “non-transitory computer-readable medium” and “computer-readable medium” should be understood to include a single medium or multiple media, such as a centralized or distributed database, and/or associated caches and servers that store one or more sets of instructions. The terms “non-transitory computer-readable medium” and “computer-readable medium” also include any tangible medium that is capable of storing, encoding or carrying a set of instructions for execution by a processor or that cause a system to perform any one or more of the methods or operations disclosed herein. As used herein, the term “computer readable medium” is expressly defined to include any type of computer readable storage device and/or storage disk and to exclude propagating signals.

The sensors 208 may be arranged in and around the vehicles 100 and 102 in any suitable fashion. In the illustrated example, the sensors 208 include the camera(s) 118 and the range detection sensors 124. The camera(s) 118 are capable of capturing video. The camera(s) 118 include a rear-facing camera (sometimes referred to as a backup camera or a rear view camera). In some examples, the camera(s) also include a front-facing camera (sometimes referred to as a dash camera). The range detection sensors 124 are ultrasonic sensors, RADAR sensors, and/or a LiDAR sensor. The range detection sensors 124 are mounted to a front bumper and a rear bumper of the responsive parked vehicles 102 to detect objects within a set range (such as, 3.28 feet (1 meter), 9.83 feet (3 meters), etc.) along a front arc and/or a rear arc of the responsive parked vehicle 102.

The ECUs 210 monitor and control the systems of the vehicles 100 and 102. The ECUs 210 communicate and exchange information via the first vehicle data bus 212. Additionally, the ECUs 210 may communicate properties (such as, status of the ECU 210, sensor readings, control state, error and diagnostic codes, etc.) to and/or receive requests from other ECUs 210. For example, the intersection blind spot assister 111 may instruct the parking assist system 116, via a message on the first vehicle data bus 212, to reposition the rear of the corresponding responsive parked vehicle 102. Some vehicles 100 and 102 may have seventy or more ECUs 210 located in various locations around the vehicle 102 communicatively coupled by the first vehicle data bus 212. The ECUs 210 (such as the parking assist system 116, etc.) are discrete sets of electronics that include their own circuit(s) (such as integrated circuits, microprocessors, memory, storage, etc.) and firmware, sensors, actuators, and/or mounting hardware. In the illustrated example, the ECUs 210 include the parking assist system 116. The parking assist system 116 (sometimes referred to as an “Intelligent Parking Assist System (IPAS)” or an “Advanced Parking Guidance System (APGS)”) can maneuver the responsive parked vehicle 102 (e.g., move forward or backward, angle the rear camera 118, etc.) without human intervention. The sensors 208 and/or the ECUs 210 of the requesting vehicle 100 and the responsive parked vehicle 102 may be different. For example, the requesting vehicle 100 may not have the parking assist system 116, the range detection sensors 124 and/or the camera(s) 118.

The first vehicle data bus 212 communicatively couples the sensors 208, the ECUs 210, the on-board computing platform 206, and other devices connected to the first vehicle data bus 212. In some examples, the first vehicle data bus 212 is implemented in accordance with the controller area network (CAN) bus protocol as defined by International Standards Organization (ISO) 11898-1. Alternatively, in some examples, the first vehicle data bus 212 may be a Media Oriented Systems Transport (MOST) bus, or a CAN flexible data (CAN-FD) bus (ISO 11898-7). The second vehicle data bus 214 communicatively couples the on-board communications platform 202, the infotainment head unit 204, and the on-board computing platform 206. The second vehicle data bus 214 may be a MOST bus, a CAN-FD bus, or an Ethernet bus. In some examples, the on-board computing platform 206 communicatively isolates the first vehicle data bus 212 and the second vehicle data bus 214 (e.g., via firewalls, message brokers, etc.). Alternatively, in some examples, the first vehicle data bus 212 and the second vehicle data bus 214 are the same data bus.

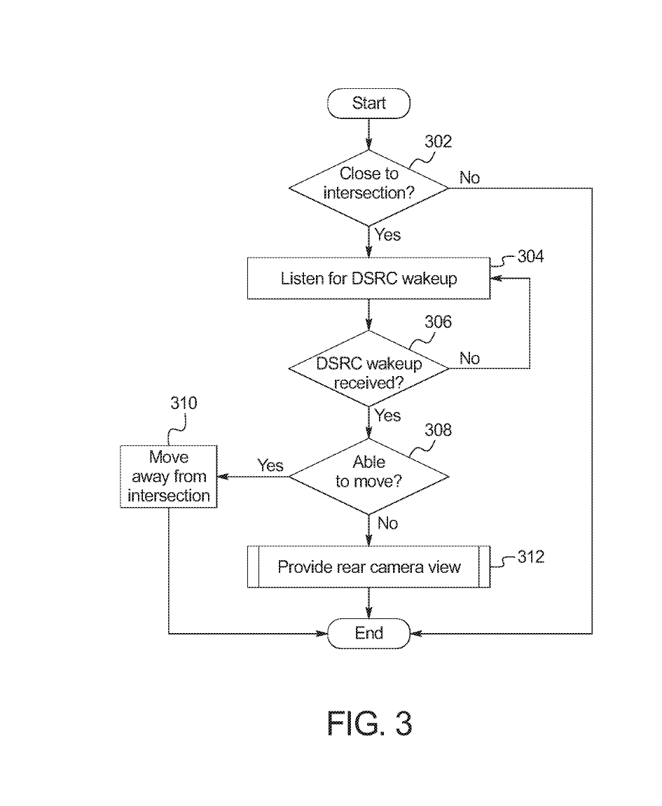

FIG. 3 is a flowchart of an example method to improve the field of view at intersections that may be implemented by the electronic components 200 of the responsive parked vehicles 102 of FIGS. 1A through 1D. Initially the intersection blind spot assister 111 determines whether the responsive parked vehicle 102 is parked too close to the intersection 104 (block 302). In some examples, the driver of the responsive parked vehicle 102 indicates (via the infotainment head unit) after parking that the responsive parked vehicle 102 is parked too close to the intersection 104. Alternatively, in some examples, the intersection blind spot assister 111 determines whether the responsive parked vehicle 102 is parked too close to the intersection 104 based on coordinates from the GPS receiver 216, a high definition map, and the range detection sensors 124.

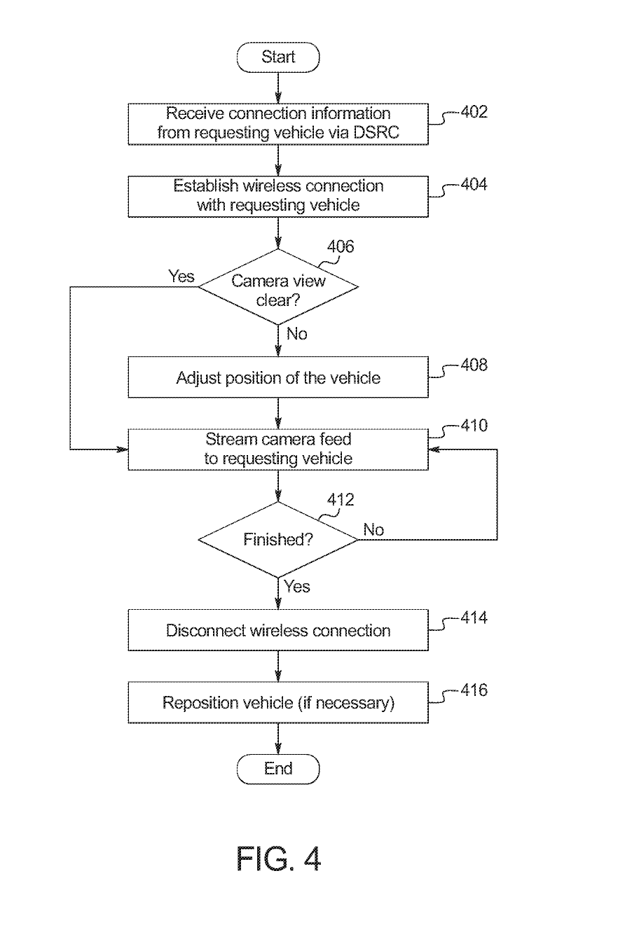

If the responsive parked vehicle 102 is parked too close to the intersection, the intersection blind spot assister 111, from time to time (e.g., every five seconds, every ten seconds, etc.) wakes up the DSRC module 114 to listen for a broadcast messages from the requesting vehicle 100 (block 304). The intersection blind spot assister 111 waits until the message from the requesting vehicle 100 is received (block 306). After the message from the requesting vehicle 100 is received, the intersection blind spot assister 111 determines whether the responsive parked vehicle 102 is able to move away from the intersection 104 (block 308). To determine whether the responsive parked vehicle 102 is able to move away from the intersection 104, the intersection blind spot assister 111 uses the range detection sensors 124 to detect objects in the direction away from the intersection. For example, if the front of the responsive parked vehicle 102 is facing the intersection, the intersection blind spot assister 111 uses the detection sensors 124 on the rear of the responsive parked vehicle 102. If the intersection blind spot assister 111 determines that the responsive parked vehicle 102 is able to move away from the intersection 104, the intersection blind spot assister 111 instructs the parking assist system 116 to move the responsive parked vehicle 102 away from the intersection 104 (block 310). Otherwise, if the intersection blind spot assister 111 determines that the responsive parked vehicle 102 is not able to move away from the intersection 104, the intersection blind spot assister 111 provides video from the rear camera 118 to the requesting vehicle 100 (block 312). An example method of providing the video from the rear camera 118 is disclosed in FIG. 4 below.

FIG. 4 is a flowchart of an example method to provide streaming video from the rear camera 118 of the responsive parked vehicle 102 to requesting vehicle 100 that may be implemented by the electronic components of FIG. 2. Initially, the intersection blind spot assister 111 receives connection information (e.g., credentials) for an ad hoc wireless network from the requesting vehicle 100 via the DSRC module 112 (block 402). The intersection blind spot assister 111 connects to the ad hoc wireless network via the WLAN module 114 (block 404). The intersection blind spot assister 111 determines whether the view from the rear camera 118 is clear (block 406). In some examples, to determine whether the view from the rear camera 118 is clear, the intersection blind spot assister 111 uses the rear range detection sensors 124 to detect any objects within a threshold distance of the responsive parked vehicle 102. For example, if there is another vehicle within 3 feet (0.91 meters) of the responsive parked vehicle 102, the intersection blind spot assister 111 may determine that the view from the rear camera 118 is not clear. If the view from the rear camera 118 is not clear, the intersection blind spot assister 111 instructs the parking assist system 116 to reposition the responsive parked vehicle 102 so that the angle (θ) between the longitudinal axis of the responsive parked vehicle 102 and the curb 126 is up to ten degrees (block 408).

The intersection blind spot assister 111 provides the video from the read camera 118 to the requesting vehicle 100 via the ad hoc wireless network (block 410). The intersection blind spot assister 111 provides the video from the read camera 118 until the requesting vehicle 100 either send a message that the requesting vehicle 100 has proceeded through the intersection 104 or the requesting vehicle 100 initiates termination of the ad hoc wireless network (block 412). The intersection blind spot assister 111 disconnects from the ad hoc wireless network (block 414). If the responsive parked vehicle 102 was repositioned at block 408, the intersection blind spot assister 111 instructs the parking assist system to return to responsive parked vehicle 102 to its original position (block 416).

The flowcharts of FIGS. 3 and/or 4 are representative of machine readable instructions that comprise one or more programs that, when executed by a processor (such as the processor 218 of FIG. 2), cause the responsive parked vehicle 102 to implement the intersection blind spot assister 111 of FIGS. 1A-1D. Further, although the example programs are described with reference to the flowcharts illustrated in FIGS. 3 and/or 4, many other methods of implementing the example intersection blind spot assister 111 may alternatively be used. For example, the order of execution of the blocks may be changed, and/or some of the blocks described may be changed, eliminated, or combined.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. A first vehicle comprising:
a camera; and
a blind spot assister configured to, when the first vehicle is parked within a threshold distance of an intersection:
establish a first wireless connection with a second vehicle in response to a request broadcast by the second vehicle;
connect to a second wireless network using credentials received via the first wireless network; and
stream video from the camera to the second vehicle via the second wireless network.

2. The first vehicle of claim 1, including a parking assist system configured to maneuver the first vehicle; and wherein the blind spot assister is configured to, when a view from the camera is blocked by an object, instruct the parking assist system to maneuver a backend of the first vehicle away from a curb.

3. The first vehicle of claim 2, wherein to determine when the view from the camera is blocked by the object, the blind spot assister is configured to detect the object via range detection sensors.

4. The first vehicle of claim 2, wherein the blind spot assister configured to, when the first vehicle is parked within the threshold distance of the intersection, in response to determining that the first vehicle is able to move away from the intersection, instruct the parking assist system to move the first vehicle away from the intersection.

5. The first vehicle of claim 4, wherein to determine that the first vehicle is able to move away from the intersection, the blind spot assister is configured to detect a third vehicle opposite the end of the first vehicle as the intersection via range detection sensors.

6. The first vehicle of claim 1, wherein the first wireless connection is established using dedicated short range communication.

7. The first vehicle of claim 1, wherein the second wireless connection is an ad hoc wireless network.

8. A method comprising:
when a first vehicle is parked within a threshold distance of an intersection:
establishing a first wireless connection with a second vehicle in response to a request broadcast by the second vehicle;
connecting to a second wireless network using credentials received via the first wireless network; and
streaming video from a camera of the first vehicle to the second vehicle via the second wireless network.

9. The method of claim 8, including, when a view from the camera is blocked by an object, instructing a parking assist system to maneuver a backend of the first vehicle away from a curb.

10. The method of claim 9, wherein to determine when the view from the camera is blocked by the object, detecting when the object is within a detection threshold using range detection sensors.

11. The method of claim 9, when the first vehicle is parked within the threshold distance of the intersection, in response to determining that the first vehicle is able to move away from the intersection, instructing the parking assist system to move the first vehicle away from the intersection.

12. The first vehicle of claim 11, wherein to determine that the first vehicle is able to move away from the intersection, detecting, via range detection sensors, when a third vehicle leaves a location on the end of the first vehicle opposite the intersection.

13. The method of claim 8, wherein the first wireless connection is established using dedicated short range communication.

14. The method of claim 8, wherein the second wireless connection is an ad hoc wireless network.

15. A tangible computer readable medium comprising instruction that, when executed, cause a first vehicle to:
when the first vehicle is parked within a threshold distance of an intersection:
establish a first wireless connection with a second vehicle in response to a request broadcast by the second vehicle;
connect to a second wireless network using credentials received via the first wireless network; and
stream video from a camera of the first vehicle to the second vehicle via the second wireless network.
